(19) United States
(12) Patent Application Publication
(10) Pub. No.: US 2023/0368957 A1
(43) Pub. Date: Nov. 16, 2023

(54) INDUCTOR COOLING

(71) Applicant: ALVIER MECHATRONICS AB, Helsingborg (SE)

(72) Inventors: Tushar BATRA, Höganäs (SE); Lars SJÖBERG, Höganäs (SE); David JOHANSSON, Höganäs (SE)

(73) Assignee: ALVIER MECHATRONICS AB, Helsingborg (SE)

(21) Appl. No.: 18/315,914

(22) Filed: May 11, 2023

(30) Foreign Application Priority Data
May 12, 2022 (EP) 22172877.7

(51) Int. Cl. H01F 27/10; H01F 27/22; H01F 17/04

(52) U.S. Cl. CPC H01F 27/105; H01F 27/22; H01F 17/045

(57) ABSTRACT

An inductor is proposed that comprises: a magnetic inner core, a coil wound around the inner core, and a heat conductor arranged within the inner core and accessible from outside the inner core and the coil for conducting heat from the inner core to outside the inner core. The inner core is of a first material having a first thermal conductivity and the heat conductor is of a second material having a second thermal conductivity that is greater than the first heat conductivity.

### CROSS REFERENCE TO RELATED APPLICATIONS

The present claims the benefit of European Application No. 22172877.7, filed on May 12, 2022. The entire contents of European Application No. 22172877.7 are hereby incorporated herein by reference in their entirety.

### TECHNICAL FIELD

The proposed technology relates to the field of inductors. The proposed technology relates specifically to the cooling of inductors and to heat conduction within inductors.

### BACKGROUND

An inductor is typically composed of a magnetic core and a coil. The core can be divided into two parts, an inner core around which the coil is wound and an outer core that is outside the coil. During operation of an inductor, heat is generated both in the core and in the coil. The heat generation in the core depends on the strength of the magnetic field, which in turn depends on the current magnitude and current frequency in the coil. It also depends on the materials of the core and the geometry of the inductor. The heat generation in the coil is mainly resistive and depends on the current magnitude, current frequency and geometry. The heating can cause the inductor to fail or reduce its performance and lifetime.

Cooling of the inductor is typically achieved by heat conduction through the core to an external heatsink. The inner core is typically positioned furthest away from the external heatsink. Thus, the cooling of the inner core is less effective. Additionally, the architecture of the inductor may cause the heat generation to be greater in the inner core then in the outer core. For example, the inner core may have smaller cross-sectional area than the outer core. This is particularly a problem if the material of the core has a low thermal conductivity, such as powdered cores. Additionally, the geometry may result in a greater thermal resistance of the inner core compared with outer core.

It is known to cool inductors with external heatsinks circulating liquid coolants, such as water. However, additional equipment is required for circulating the coolants, which complicates instalment and operation of the inductor.

### Object

The proposed technology aims at improving heat conduction in inductors, particularly in inductors with cores of solid metal-powder compounds. It further aims at improving heat conduction specifically from the inner core of inductors. It is a further objective to improve the cooling of inductors, specifically without using liquid coolants.

### SUMMARY

In a first aspect of the proposed technology, an inductor is proposed that comprises: a magnetic inner core; a coil wound around the inner core; and a heat conductor arranged within the inner core and accessible from outside the inner core for conducting heat from the inner core to outside the inner core. The inner core is of a first material and having a first thermal conductivity, and the heat conductor is of a second material having a second thermal conductivity that is greater than the first heat conductivity.

The thermal conductivity of a material is a measure of its ability to conduct heat. For example, aluminum has a thermal conductivity of 237 W/(m·K).

It is understood that the heat conductor may also be accessible from outside the coil. That the heat conductor is accessible from outside the inner core and the coil means that it can conduct heat to outside of the inductor. For example, it may be brought into contact with a heatsink for dissipating heat. Thus, the heat conductor contributes to lowering the thermal resistance and improving heat conduction from the inner core.

It is understood that the inner core is situated within the coil. This means that the extent of the inner core is determined by the coil. The inner core may form part of a greater core structure. For example, it may connect to a magnetic outer core extending on the outside of the coil, or it may be one of the inductors in an inductor pair of a transformer. It is further understood that the inductor can have additional coils wound around an additional inner core. The inner core and the additional inner core may be arranged in series and form a monolithic structure.

It is understood that the inner core confines and guides magnetic fields generated by the coil. The inner core increases the strength of the magnetic field generated by the coil.

A coil typically has an electric conductor with two terminals for electric connection. For example, the coil may be an insulated copper wire. The electric conductor may wind in overlapping spirals around the inner core. The coil may comprise a carrier structure embedding the electrical conductor. For example, the carrier structure may be of cured epoxy resin.

It is understood that the first material is a magnetic material. A magnetic material is here understood to have a relative permeability that is greater than 2, or greater than 10.

The first material may be a solid metal-powder compound. Core structures of such a material have been called powder cores. It is understood that the solid metal-powder compound comprises metal powder. For example, the first material may be Inductit® C-80 provided by Höganäs Sweden AB, or a cured compound of Iron and Silicon powder mixed with a two-component resin, such as Wevo Pox 8260 FL provided by WEVO-CHEMIE GmbH.

The solid metal-powder compound may comprise Iron, Nickel, Molybdenum, and/or Silicon in powder form. The solid metal-powder compound may comprise a binder holding the metal-powder together. For example, the binder may be a cured resin, such as a cured epoxy resin. Alternatively, the metal-powder may be fused together, for example by heat treatment or sintering. The solid metal-powder compound may be a ceramic, such as ferrite.

A solid metal-powder compound typically has a low thermal conductivity, such as 2-8 watts per meter-kelvin—W/(m·K). Thus, the proposed heat conductor is particularly advantageous in combination with such materials. However, such structures typically have significantly higher thermal conductivity than those of solid metal-powder compounds and the problem of high thermal resistance is not present.

As specified above, the coil is wound around the inner core and the heat conductor is arranged within and accessible from outside of the inner core. This means that at least a part of the heat conductor is surrounded by the coil. The heat conductor may extend through the inner core and may be accessible from outside the inner core on opposite sides of the inner core or the inductor.

The heat conductor may be of a single piece of metal. This means that the heat conductor is monolithic. Preferably, the heat conductor is of aluminum. Throughout these specifications, the term “aluminum” is understood to encompass aluminum alloys. The heat conductor may be impermeable, or imperforated, which means that it does not form any through-going holes through which a fluid can pass. This contributes to an improved heat conduction but has the disadvantage that no cooling fluid can pass through the heat conductor.

The thermal conductivity of the second material may be at least three times, five times, or ten times greater than the thermal conductivity of the first material. It has been found that a relevant cooling effect is achieved at these differences in thermal conductivity. For example, a powder core may have a thermal conductivity of about 50 W/(m·K) and the heat conductor may be of aluminum having a thermal conductivity of 237 W/(m·K).

Preferably, the second material is a non-magnetic material. Worded differently, the heat conductor may be non-magnetic. A non-magnetic material is here understood to have a relative permeability that is less than 2. For example, the second material may be of aluminum having a relative permeability of 1.000022.

The heat conductor may contact, be attached to, or adhere to, the inner core. For example, the heat conductor may be attached to the inner core by a shrink fit, a press fit, or by cooperating threads on the inner core and the heat conductor. Alternatively, the inner core may be formed around the heat conductor, as in the manufacturing method described below. Contact between the heat conductor and the inner core contributes to a better heat conduction between the inner core and the heat conductor.

The heat conductor may be a monolithic structure. The inner core and the heat conductor may jointly form an impermeable, or imperforated, composite structure. This means that there are no holes in the structure, such as blind holes or through-going holes. It also means that there are no gaps between the inner core and the heat conductor. Worded differently, the heat conductor may prevent a fluid from passing through the inductor.

Alternatively, the heat conductor may be loosely fitted within the inner core. This means that the position of the heat conductor can be shifted relative to the inner core. Even though the heat conduction between the inner core and the heat conductor will be reduced by the loosely fitted heat conductor, it has been found that it still contributes to a lowered thermal resistance. The loosely fitted heat conductor allows for thermal expansion of the heat conductor and the inner core, which could otherwise result in structural failures. This problem is typically not present in laminated cores of silica steel.

The inner core may have a cylindrical geometry defining a central axis, and the heat conductor may be located at, be or centered on, the central axis. Worded differently, the heat conductor may be located at the center of the inner core. This positions the heat conductor where the thermal resistance typically is the greatest. The heat conductor may have a cylindrical geometry defining a central axis, for example it may have a circular transverse cross-section. The cylindrical geometry of the inner core and the cylindrical geometry of the heat conductor may be coaxial, or the central axes of the inner core and the heat conductor may be colinear.

The inner core may form a central hole. The central hole may be aligned with and extending along the central axis, and the heat conductor may be fitted within the central hole. The central hole may be centered on the central axis. The central hole may have a first circular-cylindrical geometry and the heat conductor may have a matching second circular-cylindrical geometry. Worded differently, the heat conductor may conform to the central hole. For example, the heat conductor may be a solid rod of metal with a circular cross-section. The central hole may be through-going hole. This allows for the heat conductor to be accessible on opposite sides of the inner core.

The inner core may have a transverse first cross section with a first area, the heat conductor may have a transverse second cross section at the first cross section with a second area, wherein the second area is in the range 10-30%, or 15-25% of the first area, or less than 30%, 25%, or 20% of the first area. Worded differently, in a transverse cross section of the inductor, the area of the inner core may be less than five times the area of the heat conductor. It has been found that this contributes to an efficient cooling, particularly if the thermal conductivity of the second material is more than three times greater than that of the first material. Here, the term transverse is understood as an orientation relative to the central axis defined by the cylindrical geometry of the inner core.

The inductor may be a gapped inductor. The inner core may form an air gap. It is understood that air gaps reduce the effects of saturation, for example to increase the reluctance and enable more energy to be stored before core saturation. It is further understood that the air gap can be filled with a non-magnetic material. For example, the air gap may be filled with a cured epoxy resin. The air gap may extend from the coil to the heat conductor, for example transversely to the abovementioned central axis defined by the cylindrical geometry of the core. It may divide the inner core in two inner core portions that are separated by the air gap. Typically, the air gap has a lower thermal conductivity than the first material, thus increasing the thermal resistance of the inner core. This reduced performance is to some degree compensated for by the heat conductor, particularly if the heat conductor is through-going.

The heat conductor may extend from the inner core, for example to extend though an outer core connected to the inner core.

The inductor may further comprise: a magnetic outer core extending on the outside of the coil and connecting to the inner core. The outer core limits the outward heat transfer from the coil heat, which means that more heat typically flows from the coil to the inner core and the effect of the heat conductor becomes more critical.

The outer core may be of the same material as the inner core. The outer core may be connected to the inner core. Preferably, the outer core is seamlessly connected to the inner core. The inner core and the outer core may jointly form a monolithic structure. The outer core may form a closed loop with the inner core. Worded differently, the outer core may connect to the inner core at opposite ends of the coil, or at opposite ends of the inner core. The outer core may be positioned at, or at least partly cover the coil on, at least four sides of the coil, wherein it connects to the inner core on two of the at least four sides. It is understood that a three-dimensional object, such as the coil and the outer core, has six sides. The six sides can be ordered in opposed pairs that are arranged orthogonally to one another.

The outer core may surround, or cover, the coil completely, which means that it surrounds, or covers, the coil on all its sides. The outer core may contact, or adhere to, the coil.

The heat conductor may be accessible from outside the outer core, which means that it can be brought into contact with a heatsink for dissipating heat. The heat conductor may be accessible from outside the outer core on opposite sides of the outer core or the inductor. This means that the heat conductor extends through the inductor.

The inductor may further comprise: a heatsink contacting, or coupled to, the heat conductor and configured to receive heat from the heat conductor. This contributes to an improved heat conduction from the inner core. For example, the heatsink may be connected, or joined, to the heat conductor. For example, it may be connected by a screw fit. It is understood that the heatsink is external to the inner core, the coil, and the outer core.

The heatsink may enclose the outer core. The outer core may contact, adhere, and/or fuse to heatsink. This is particularly advantageous if the outer core surrounds the coil completely. More specifically, the heatsink may enclose the outer core on at least five sides of the outer core. The outer core may contact, adhere, and/or fuse to heatsink at the at least five sides.

It is understood that the heat conductor contacts the heatsink at one of the sides of the heat conductor. It may further contact the heatsink at the opposite side of the heat conductor.

The heatsink may by itself form, or constitute, a mold or container for holding a fluid. For example, the heatsink may form, or define, a cylinder having at least one closed end. The cylinder may have a circular, square, or rectangular cross-section. The heat conductor may contact the closed end of the cylinder. These features allow for favorable methods of manufacturing an inductor, for example by molding or casting, which is further described below.

The heatsink may be a passive heatsink. For example, it may comprise heat dissipating fins for convective air cooling. Alternatively, the heatsink may be an active heatsink. For example, it may comprise a conduit for conducting a coolant. Preferably, the different parts of the heatsink, or the heatsink as a whole, are of metal, such as aluminum.

The heatsink may comprise: a cover and a first heat-transfer plate, or first bridge, contacting, or coupled to, the heat conductor and interconnecting the heat conductor and the cover for conducting heat from the heat conductor to the cover. The cover may comprise, or form, heat dissipating fins. It is understood that the first heat-transfer plate may be connected, or joined, to the heat conductor.

The heatsink may comprise: a second heat-transfer plate, or second bridge, contacting, or coupled to, the heat conductor and interconnecting the heat conductor and the cover for conducting heat from the heat conductor to the cover, and the first heat-transfer plate and the second heat transfer plate connect to the heat conductor at opposite sides of the heat conductor. It is understood that the second heat-transfer plate may be connected, or joined, to the heat conductor.

The cover may contact the outer core for conducting heat from the outer core. Each of the first heat-transfer plate and the second heat-transfer plate may contact the outer core for conducting heat from the outer core. This contributes to an improved cooling of the inductor.

The heat conductor may extend transversely relative to, or normal to, the first heat-transfer plate. As described above, the heat conductor may have a cylindrical geometry defining a central axis. Worded differently, the heat-transfer plate may be oriented transversely to the central axis of the heat conductor. It is understood that the corresponding relationships may apply also for the second heat conductor.

The cover may encircle the outer core and form a cavity in which the outer core is positioned, wherein the cover has, or forms, a first opening to the cavity and the heat conductor is contacting, or coupled to, the first heat-transfer plate at the first opening. The outer core may be removable from the cavity, or insertable into the cavity, via the first opening. The first heat-transfer plate may cover the first opening. The cavity may conform to the shape of the outer core. That the cover encircles the outer core means that it covers at least four sides of the outer core where the four sides can be arranged in pairs that are on opposite sides of the outer core. Worded differently, the cover may be annular.

The cover may have, or form, a second opening to the cavity and the heat conductor is contacting, or coupled to, the heat-transfer plate at the second opening. The outer core may be removable from the cavity, or insertable into the cavity, via the second opening. The second heat-transfer plate may cover the second opening.

As described above, the heat conductor may have a cylindrical geometry. The cavity of the cover may have a cylindrical geometry that is coaxial with the cylindrical geometry of the heat conductor. Worded differently, the cylindrical geometry of the cavity may define a central axis that is colinear with the central axis of the cylindrical geometry of the heat conductor.

The cover may be monolithic, which means that it constitutes a single element. For example, the cover may be an extruded structure that forms the cylindrical geometry of the cavity together with the first opening and the second opening.

The cover may comprise: a side panel, or side wall; wherein the first heat-transfer plate interconnects the heat conductor and the side panel for conducting heat from the heat conductor to the side panel. The side panel may comprise, or form, heat dissipating fins. If present, the second heat-transfer plate may also interconnect the heat conductor and the side panel for conducting heat from the heat conductor to the side panel.

The cover may comprise four side panels that jointly form, or outline, a cavity in which the outer core is positioned. The four side panels may be arranged in pairs that are on opposite sides of the outer core. Each side panel may be arranged as and have the features of the above-described side panel. Each side panel may form a planar side facing the outer core. This means that the cavity has a rectangular transverse cross section. The planar side of each side panel may contact the outer core.

In a second aspect of the proposed technology, a method for manufacturing an inductor comprising a coil and a heat conductor is proposed. The method comprises: positioning the heat conductor within the coil, wherein the heat conductor is spaced apart from the coil; providing, or introducing, a fluid material between the heat conductor and the coil to form a precursor inner core; and solidifying the fluid material of the precursor inner core to form a magnetic inner core of a first material, wherein the first material has a first thermal conductivity, and the heat conductor is of a second material having a second thermal conductivity that is greater than the first heat conductivity.

It is understood that the fluid material is configured to form the first material after solidification. It is further understood that the resulting first material is a magnetic material.

The fluid material may be in contact with the heat conductor. This way, the heat conductor is in contact with and may adhere to the resulting inner core. The fluid material may also be in contact with the coil. This means that the resulting inner core is in contact and may adhere to, the coil.

The fluid material may comprise metal powder. Worded differently, the fluid material may be a fluid metal-powder compound. For example, the fluid material may be in powder-form and comprise different metal powders. It may further comprise a binder for binding the metal powders together in the solidification. Alternatively, the fluid material may be in liquid form and comprise different metal powders suspended in a carrier liquid.

The fluid material may be provided, or introduced, with the heat conductor being accessible from outside the fluid material. For example, the heat conductor may extend from, or at least surface, the fluid material. Worded differently, the heat conductor may be accessible from outside the precursor inner core. This means that it will be accessible from outside the resulting inductor.

The fluid material may also be provided, or introduced, outside of the coil to form a precursor outer core connected to the precursor inner core. This way, the resulting inner core and outer core jointly forms a monolithic structure after solidification. As mentioned above, the fluid material may be in contact with the coil. This means that the resulting outer core is in contact with and may adhere to the coil.

The heat conductor and the coil may be placed in a mold. Worded differently, positioning the heat conductor within the coil may encompass: placing the coil in a mold with the heat conductor positioned within the coil. It is understood that the coil may be placed in the mold together with the heat conductor. It is also understood that the heat conductor may be joined to the mold before the coil is positioned in the mold. This is advantageous if the mold forms an integral part of the inductor. For example, heat conductor and the mold may form a monolithic structure, or the heat conductor is attached to the mold by a fastener, such as a screw.

The fluid material may then be provided, or introduced, between, or at least partly between, the coil and the mold to form the precursor outer core. Worded differently, providing the fluid material may then encompass: providing, or introducing, a fluid material between the heat conductor and the coil to form a precursor outer core and between, or at least partly between, the coil and the mold to form a precursor outer core connected to the precursor inner core. This way, the resulting inner core and outer core jointly form a monolithic structure after solidification. In the solidifying of the fluid material, a magnetic outer core of the first material is formed from the precursor outer core. Worded differently, the solidifying the fluid material may then encompass: solidifying the fluid material of the precursor inner core and the precursor outer core to form a magnetic inner core and a magnetic outer core of a first material.

The heat conductor may be accessible from outside the precursor outer core. This means that it will be accessible from outside the resulting outer core.

As mentioned above, the fluid material may be in contact with the coil. This means that the resulting outer core is in contact and may adhere to the coil. The fluid material may be in contact with the mold. This means that the resulting outer core is in contact with and may adhere to the mold.

The fluid material may be in powder form. For example, the fluid material may be a precursor to Inductit® C-80. Providing, or introducing, the fluid material may then comprise: potting or compacting the fluid material between the heat conductor and the coil. It may further comprise: potting or compacting the fluid material outside of the coil. If a mold is present, providing, or introducing, the fluid material may comprise: potting or compacting the fluid material in the mold. It is understood that this includes potting or compacting the fluid material between the heat conductor and the coil and between, or at least partly between, the coil and the mold.

If the fluid material is in powder form, the fluid material may be solidified by heat treatment or sintering. Worded differently, solidifying the fluid material may encompass: solidifying the fluid material by heat treatment or sintering. For example, the fluid material may comprise a binder in powder-form that melts when heated and binds the metal powder together.

The fluid material may be in liquid form. The fluid material may comprise a carrier liquid with the metal powder suspended in the carrier liquid. For example, the fluid material may be a compound of Iron and Silicon powder suspended in Wevo Pox 8260 FL. Providing, or introducing, the fluid material may then comprise: casting or injecting the fluid material between the heat conductor and the coil. It may further comprise: casting or injecting the fluid material outside of the coil. If a mold is present, providing, or introducing, the fluid material may comprise: casting or injecting the fluid material in the mold. It is understood that this includes casting or injecting the fluid material between the heat conductor and the coil and between, or at least partly between, the coil and the mold.

It is understood that casting employs the force of gravity to introduce the fluid material and that injecting employs an elevated pressure to introduce the fluid material. The pouring or injecting of the fluid material may involve: injection molding, sand casting, and slip casting.

If the fluid material is in liquid form, it may comprise a resin. The resin may constitute the abovementioned carrier liquid. For example, the resin may be a thermosetting resin or an epoxy resin. The fluid material may be solidified by curing. Worded differently, solidifying the fluid material may encompass: solidifying the fluid material by curing. In the case of a thermosetting resin, this may encompass heating the fluid material. In the case of an epoxy resin, this may encompass resting the fluid material for a curing time of the epoxy resin.

The method may further comprise: removing the resulting structure, or inductor, from the mold. It is understood that this is after solidifying the precursor inner core and the precursor outer core.

Alternatively, the mold may form a permanent, or integrated, part of the inductor. The fluid material may be configured to adhere, or bond, to the mold after solidification. The mold may be attached, or adhere, to the resulting outer core.

The inductor may comprise a heatsink, wherein the abovementioned mold, or container, is, or constitutes, the heatsink. Positioning the heat conductor within the coil may further comprise: placing the heat conductor in contact with the heatsink. This allows for an efficient heat conduction between the heat conductor and the heatsink.

The heat conductor may be joined to the heatsink, for example by a screw fit or a weld. The heat conductor and the heatsink may form a monolithic structure. This further contributes to an improved heat conduction.

As mentioned above, the mold, may be attached, or adhere, to the resulting outer core. Thus, this extends to the heatsink. This further contributes to an improved heat conduction within the inductor.

The inductor resulting from the abovementioned manufacturing method may further comprise any of the features described in relation to the first aspect of the proposed technology.

An alternative method for manufacturing an inductor is proposed, wherein the method comprises: providing a precursor inductor comprising a magnetic inner core of a first material and a coil wound around the inner core, wherein the inner core forms a central hole that is accessible from outside the inner core. The method further comprises: providing, or introducing, a fluid precursor second material in the central hole; and solidifying the fluid precursor second material to form a heat conductor of a second material that is accessible from outside the inner core, wherein the first material has a first thermal conductivity, and the second material has a second thermal conductivity that is greater than the first heat conductivity.

The fluid precursor second material may be provided, or introduced, in the central hole by casting or injecting the fluid precursor second material in the central hole. The first material may be a solid metal-powder compound. The fluid precursor second material may be in contact with the inner core. This way, the resulting heat conductor is in contact with and may adhere to the inner core. The fluid precursor second material may be molten aluminum and the second material may be solid aluminum. It is understood that the first material can withstand the temperature of the molten aluminum.

The precursor inductor or the resulting inductor may comprise any of the features described in relation to the first aspect of the proposed technology. For example, the precursor inductor may comprise an outer core connected to the inner core, and the central hole formed by the inner core of the precursor inductor may be through-going.

### BRIEF DESCRIPTION OF THE DRAWINGS

A more complete understanding of the abovementioned and other features and advantages of the proposed technology will be apparent from the following detailed description in conjunction with the appended drawings, wherein:

FIGS. 1a-c schematically illustrate a side view, a longitudinal cross-sectional view, and a transverse cross-sectional view, respectively, of an embodiment of the proposed technology.

FIG. 2 schematically illustrates a longitudinal cross-sectional view of another embodiment of the proposed technology.

FIG. 3 schematically illustrates a longitudinal cross-sectional view of another embodiment of the proposed technology.

FIG. 4 schematically illustrates a longitudinal cross-sectional view of another embodiment of the proposed technology.

FIG. 5 schematically illustrates a longitudinal cross-sectional view of another embodiment of the proposed technology.

### DETAILED DESCRIPTION

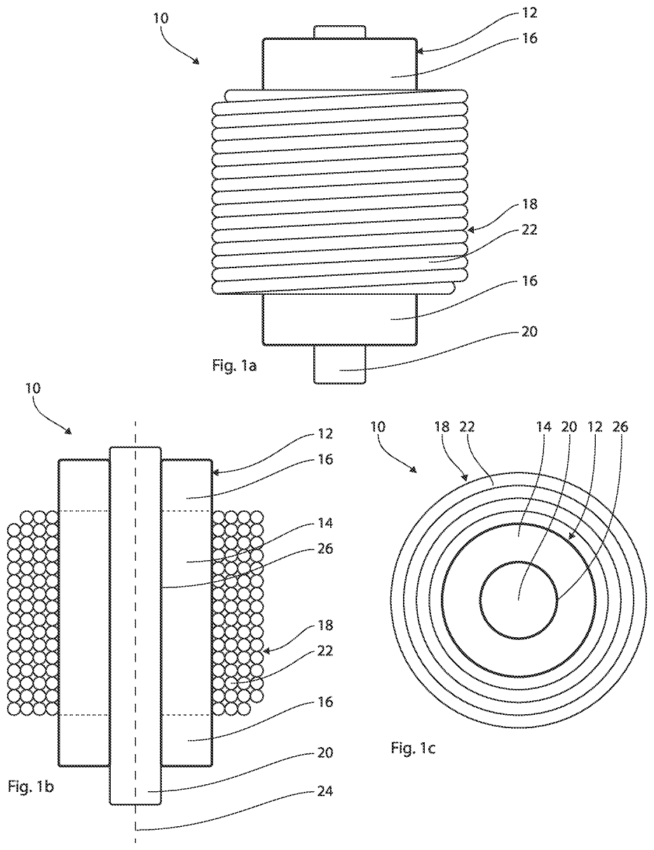

FIGS. 1a-c schematically illustrate an embodiment of an inductor 10. The inductor has a magnetic inner core 14 of a solid metal-powder compound. A coil 18 of an electrical conductor 22 in the form of insulated copper wire is wound around the inner core 14. A heat conductor 20 in the form of a single piece of solid aluminum alloy is arranged within the inner core 14. The heat conductor 20 is loosely fitted within the inner core 14. In an alternative embodiment it has been press fitted into the inner core 14.

As can be seen in FIGS. 1a-c, the inner core 14 has a cylindrical geometry defining a central axis 24. The inner core 14 forms a through-going central hole 26 aligned with, centered on, and extending along the central axis 24. The central hole 26 and the heat conductor 20 conform to one another by matching circular-cylindrical geometries, as can be seen in FIG. 1c. The central axis 24 of the inner core 14, the central hole 26, and the heat conductor are colinear. The transverse cross section of the inner core 14 has an area that is three times greater than the area of the transverse cross section of the heat conductor 20.

The inductor 10 has a magnetic outer core 16 extending on the outside of the coil 18. The outer core 16 and the inner core 14 jointly form a monolithic core structure 12 of the solid metal-powder compound. The two cores 14 and 16 are connected at the horizontal dashed lines indicated in FIG. 1b.

The heat conductor 20 is a monolithic rod that extends through the inner core 14. The heat conductor 20 extends from the inner core 14 into the outer core 16 and is accessible from outside the outer core 14 on opposite sides of the outer core 16. Thus, it is also accessible from outside the inner core 10 and the coil 18 on opposite sides of the inner core 14. This way, the heat conductor can conduct heat from the inner core 14 to outside the inner core 14. For example, the heat conductor 20 can be connected to a separate external heatsink (not shown).

The aluminum alloy of the heat conductor 20 has a thermal conductivity that is more than three times greater than the thermal conductivity of the solid metal-powder compound of the inner core 14.

The inductor 10 in FIGS. 1a-c is manufactured from a prefabricated core structure 12 by winding the electrical conductor 22 on the prefabricated core structure 12 to form the coil 18. The coil 18 then defines the inner core 14 and the outer core 16. The above-described central hole 26 has been formed in the manufacturing of the core structure 12. The heat conductor 20 is provided by loosely fitting the rod of aluminum alloy in the central hole 26.

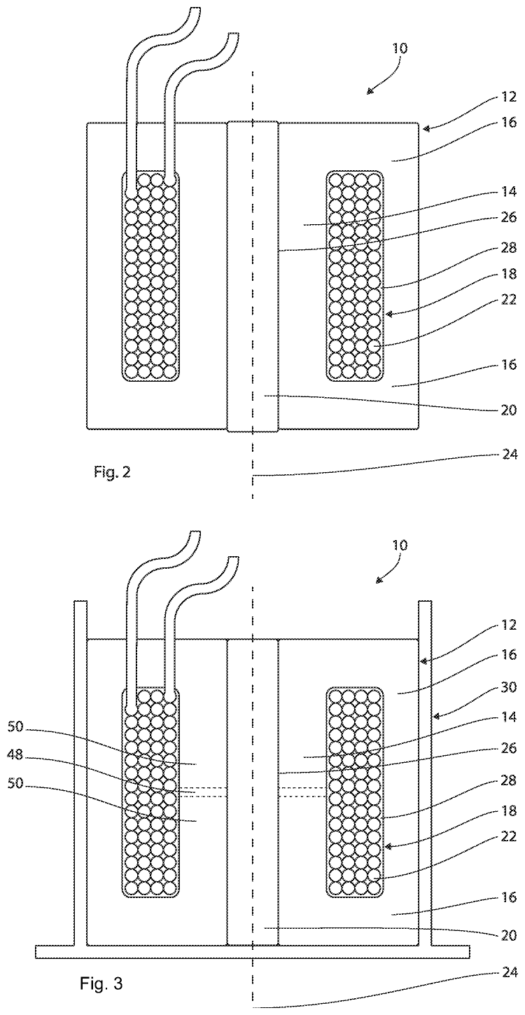

FIG. 2 schematically illustrates another embodiment of an inductor 10. It has the features of the inductor described in relation to FIG. 1. Additionally, the coil 18 has a carrier structure 28 of cured epoxy resin that embeds and supports the electrical conductor 22. The outer core 16 surrounds the coil 18 completely and connects to the inner core 14 at opposite ends of the inner core 14, thus forming a closed loop with the inner core 14.

In the manufacturing of the inductor 10 in FIG. 2, the coil 18 and the core structure 12 are prefabricated with the central hole 26 formed together with the core structure 12. The heat conductor 20 is provided by press fitting a rod of aluminum alloy into the central hole 26. Alternatively, the coil 18 and the core structure 12 are prefabricated, and molten aluminum alloy is cast into the central hole 26 such that the molten aluminum alloy contacts the inner core 14. The molten aluminum alloy is cooled and solidifies to form a heat conductor 20 of solid aluminum alloy.

FIG. 3 schematically illustrates another embodiment of an inductor 10. It has the features of the inductor described in relation to FIG. 2. Additionally, the inductor 10 has a heatsink 30 that is external to the inner core 14, the coil 18, and the outer core 16. The heatsink 30 encloses the outer core 16 and the heat conductor 20 contacts the heatsink 30 such that heat is conducted away from the heat conductor 20. In alternative embodiments, the heat conductor 20 may be joined to the heatsink 30. For example, it may be connected by a screw fit or a weld. It is understood that the heatsink 30 is external to the inner core 14, the coil 18, and the outer core 16.

The heatsink 30 as such defines a cylinder with circular cross-section and a closed end, thus forming a mold 30 that can hold a liquid. The heat conductor 20 contacts the heatsink 30 at the closed end.

In an alternative embodiment, the inductor 10 is a gapped inductor with the inner core 14 forming an air gap 48. The air gap 48 is filled with a cured epoxy resin. The air gap 48 extends from the coil 18 to the heat conductor 20 transversely to the central axis 24 and divides the inner core 14 in two inner core portions 50 that are separated by the air gap 48. The inductor in FIG. 3 can be manufactured by placing the heat conductor 20 and the coil in the mold 30 formed by the heatsink 30. The heat conductor 20 is positioned within the coil 18 and contacts the mold 30. A fluid metal-powder compound composed of a thermosetting resin carrying metal powders is provided. In an alternative embodiment, an epoxy resin is used instead of the thermosetting resin. This fluid material is in liquid form and is cast into the mold 30 such that it is introduced between the heat conductor 20 and the coil 18 to form a precursor inner core and between the coil 18 and the mold 30 to form a precursor outer core that surrounds the coil 18. In an alternative embodiment, the fluid material is injected into the mold 30 under pressure.

The fluid material contacts the conductor 20, the coil 18, and the mold 30. The precursor inner core and the precursor outer core join seamlessly at opposite ends of the coil 18.

The fluid material is then heated, for example by placing the mold 30 in an oven, such that it cures and solidifies, thus forming the abovementioned solid metal-powder compound. If the fluid metal-powder compound instead is based on an epoxy resin, the fluid material is rested until it is fully cured. The precursor inner core forms the inner core 14, which adheres to the heat conductor 20 and the coil 18. The precursor outer core forms the outer core 16, which adheres to the coil 18 and the mold 30, which also forms the heatsink 30.

In the alternative embodiment in which the inductor 10 is a gapped inductor, the inductor is manufactured as described above with the fluid metal-powder compound being based on an epoxy resin. The casting of the fluid material is interrupted, and a thin layer of pure epoxy resin is cast between the coil 18 and the heat conductor 20, whereafter the casting of the fluid material is resumed. Once cured, the pure epoxy resin forms the airgap 48.

The inductor in FIG. 3 can alternatively be manufactured by placing the heat conductor 20 and the coil in the mold 30 formed by the heatsink 30. The heat conductor 20 is positioned within the coil 18 and contacts the mold 30. A fluid metal-powder compound in powder-form is provided. This fluid material is potted and compacted in the mold 30 such that it is introduced between the heat conductor 20 and the coil 18 to form a precursor inner core and between the coil 18 and the mold 30 to form a precursor outer core that surrounds the coil 18. The fluid material contacts the conductor 20, the coil 18, and the mold 30. The precursor inner core and the precursor outer core join seamlessly at opposite ends of the coil 18.

The fluid metal-powder compound includes a binder in powder form. The fluid material is heated such that the binder melts. After cooling, the binder holds the resulting solid metal-powder compound together. In an alternative embodiment, the fluid metal-powder compound is composed of metal powders that is sintered in the mold 30 to form the solid metal-powder compound.

The precursor inner core forms the inner core 14, which contacts the heat conductor and the coil 18. The precursor outer core forms the outer core 16, which contacts the coil 18 and the mold 30.

In the embodiment of FIG. 3, the mold 30 is an integral part and constitutes the heatsink 30 of the inductor 10. In an alternative embodiment, the outer core 16 together with the heat conductor 10, the inner core 14, and the coil 18 are removed from the mold 30, thus providing an inductor 10 having the features described in relation to FIG. 2. Instead of the heat connector being press fitted into the central hole 26, the inner core has now been formed around the heat conductor 20.

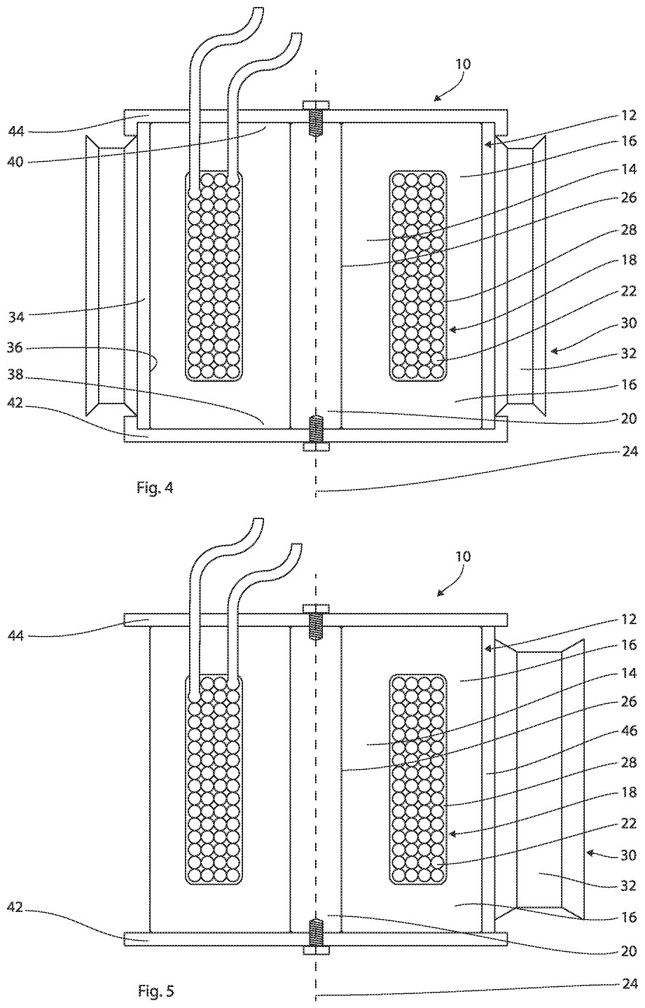

FIG. 4 schematically illustrate another embodiment of an inductor 10. The inductor 10 has the features described in relation to FIG. 2. Additionally, it has an external heatsink 30 with a cover 34 that forms heat dissipating fins 32. The cover 34 is a single piece of extruded aluminum alloy that encircle the outer core 16 and form a cavity 36 in which the outer core 16 is positioned. As described above, the heat conductor 20 has a cylindrical geometry defining a central axis 24 and the cavity 36 has a cylindrical geometry defining a colinear central axis 24.

The cover 34 conforms to and contacts the outer core 16 such that heat can be conducted to the cover 34. The cover 34 has a first opening 38 and a second opening 40 to the cavity 36. The outer core 16 together with the heat conductor 20, the inner core, and the coil 18 can be removed from or inserted into the cavity 36 via the first opening 38 or the second opening 40.

The heatsink 30 has a first heat-transfer plate 42 that is connected to the heat conductor 20 by a screw at the first opening 38. The heatsink 30 further has a second heat-transfer plate 44 that is connected to the heat conductor 20 by a screw at the second opening 40. This way, the heatsink 30 connected to the heat conductor 20 on opposite sides of the heat conductor 20. Each of the first heat-transfer plate 42 and the second heat-transfer plate 44 interconnects the heat conductor 20 and the cover 34 such that heat can be conducted from the heat conductor 20 to the cover 34. Each of the first heat-transfer plate 42 and the second heat-transfer plate 44 also contacts the outer core 16 such that they conduct heat from the outer core 16 to the cover 34. The first heat-transfer plate 42 covers the first opening 38 leading to the cavity 36, and second heat-transfer plate 44 covers the second opening 40 leading to the cavity 36.

The inductor 10 shown in FIG. 4 can be manufactured by inserting the inductor 10 described in relation to FIG. 2 into the cavity 36 formed by the cover 34. The first heat-transfer plate 42 and the second heat-transfer plate 44 are then attached to the heat conductor and connected to the cover 34 as described above.

FIG. 5 schematically illustrate another embodiment of an inductor 10. The inductor 10 has the features described in relation to FIG. 2. Additionally, it has an external heatsink 30 with a side panel 46 that forms heat dissipating fins 32. The side panel 46 is a single piece of extruded aluminum alloy.

The side panel conforms to and contacts the outer core 16 such that heat can be conducted to the side panel 46. The heatsink 30 has a first heat-transfer plate 42 that is connected to the heat conductor 20 by a screw at one end of the heat conductor 20. The heatsink 30 further has a second heat-transfer plate 44 that is connected to the heat conductor 20 by a screw at the opposite end of the heat conductor 20. Each of the first heat-transfer plate 42 and the second heat-transfer plate 44 interconnects the heat conductor 20 and the side panel 46 such that heat can be conducted from the heat conductor 20 to the side panel 46. Each of the first heat-transfer plate 42 and the second heat-transfer plate 44 also contacts the outer core 16 such that they conduct heat from the outer core 16 to the side panel 46.

In an alternative embodiment, the inductor has four side panels that jointly outline a cavity in which the outer core is positioned. The four side panels are arranged in pairs that are on opposite sides of the outer core 16. Each side panel is arranged and connected as the above-described side panel 46.

The inductor 10 shown in FIG. 5 can be manufactured from the inductor 10 described in relation to FIG. 2 by attaching the first heat-transfer plate 42 and the second heat-transfer plate 44 to the heat conductor 20 and connecting them to the side panel 46 as described above.

### ITEM LIST

10 inductor
12 core structure
14 inner core
16 outer core
18 coil
20 heat conductor
22 electric conductor
24 central axis of inner core, heat conductor, and cavity
26 central hole
28 carrier structure of coil
30 heatsink or mold
32 heat dissipating fins
34 cover
36 cavity
38 first opening
40 second opening
42 first heat-transfer plate
44 second heat-transfer plate
46 side panel
48 air gap
50 inner core portions

### EMBODIMENTS

1. An inductor (10) comprising:
   a magnetic inner core (14);
   a coil (18) wound around the inner core (14); and
   a heat conductor (20) arranged within the inner core (14) and accessible from outside the inner core (14) and the coil (18) for conducting heat from the inner core (14) to outside the inner core (14), wherein the inner core (14) is of a first material having a first thermal conductivity, and the heat conductor (20) is of a second material having a second thermal conductivity that is greater than the first thermal conductivity.
2. The inductor according to embodiment 1, wherein the first material is a solid metal-powder compound.
3. The inductor according to embodiment 2, wherein the thermal conductivity of the second material is at least three times, five times, or ten times greater than the thermal conductivity of the first material.
4. The inductor according to embodiment 2 or 3, wherein the heat conductor (20) extends through the inner core (14) and is accessible from outside the inner core (10) on opposite sides of the inner core (14).
5. The inductor according to any of the embodiments 2 to 4, wherein the inner core (14) has a cylindrical geometry defining a central axis (24), and the heat conductor (20) is located at the central axis (24).
6. The inductor according to any of the embodiments 2 to 5, wherein the inductor (10) further comprises:
   a magnetic outer core (16) extending on the outside of the coil (18) and connecting to the inner core (14), wherein the outer core (16) is of the same material as the inner core (14), and the inner core (14) and the outer core (16) jointly form a monolithic structure.
7. The inductor according to any of the embodiments 2 to 6, wherein the inductor (10) further comprises:
   a heatsink (30) coupled to the heat conductor (20) and configured to receive heat from the heat conductor (20).
8. The inductor according to embodiment 7, wherein the heatsink (30) comprises: a cover (34) and a first heat-transfer plate (42) coupled to the heat conductor (20) and interconnecting the heat conductor (20) and the cover (34) for conducting heat from the heat conductor (20) to the cover (34), and the cover comprises heat dissipating fins (32).
9. The inductor according to embodiment 8, wherein the cover (34) encircles the outer core (16) and form a cavity (36) in which the outer core (16) is positioned, the cover (34) has a first opening (38) to the cavity (36) and the heat conductor (20) is coupled to the first heat-transfer plate (42) at the first opening (38).
10. The inductor according to embodiment 8, wherein the cover (34) comprises: a side panel (46); wherein the first heat-transfer plate (42) interconnects the heat conductor (20) and the side panel (46) for conducting heat from the heat conductor (20) to the side panel (46).
11. A method for manufacturing an inductor (10) comprising a coil (18) and a heat conductor (20), wherein the method comprises:
   positioning the heat conductor (20) within the coil (18), wherein the heat conductor (20) is spaced apart from the coil (18);
   providing, a fluid material between the heat conductor (20) and the coil (18) to form a precursor inner core (14); and
   solidifying the fluid material of the precursor inner core to form a magnetic inner core (14) of a first material,
   wherein the first material has a first thermal conductivity, and the heat conductor (20) is of a second material having a second thermal conductivity that is greater than the first heat conductivity.
12. The method according to embodiment 11, wherein the fluid material is a fluid metal-powder compound.
13. The method according to embodiment 12, wherein the fluid material is also provided outside of the coil (18) to form a precursor outer core connected to the precursor inner core.
14. The method according to embodiment 13, wherein the heat conductor (20) and the coil are placed in a mold (30) and the fluid material is provided between the coil (18) and the mold (30) to form the precursor outer core.

1. An inductor comprising:
a magnetic inner core;
a coil having an electrical conductor wound around the inner core, wherein the electrical conductor is embedded in a carrier structure; and
a heat conductor arranged within the inner core and accessible from outside the inner core and the coil for conducting heat from the inner core to outside the inner core, wherein the inner core is of a first material having a first thermal conductivity, and the heat conductor is of a second material having a second thermal conductivity that is greater than the first thermal conductivity.

2. The inductor according to claim 1, wherein the first material is a solid metal-powder compound.

3. The inductor according to claim 1, wherein the thermal conductivity of the second material is at least three times greater than the thermal conductivity of the first material.

4. The inductor according to claim 1, wherein the heat conductor extends through the inner core and is accessible from outside the inner core on opposite sides of the inner core.

5. The inductor according to claim 1, wherein the inner core has a cylindrical geometry defining a central axis, and the heat conductor is located at the central axis.

6. The inductor according to claim 1, wherein the inductor further comprises:
a magnetic outer core extending on the outside of the coil and connecting to the inner core, wherein the outer core is of the same material as the inner core, and the inner core and the outer core jointly form a monolithic structure.

7. The inductor according to claim 1, wherein the inductor further comprises:
a heatsink coupled to the heat conductor and configured to receive heat from the heat conductor.

8. The inductor according to claim 7, wherein the heatsink comprises: a cover and a first heat-transfer plate coupled to the heat conductor and interconnecting the heat conductor and the cover for conducting heat from the heat conductor to the cover, and the cover comprises heat dissipating fins.

9. The inductor according to claim 8, wherein the cover encircles the outer core and form a cavity in which the outer core is positioned, the cover has a first opening to the cavity and the heat conductor is coupled to the first heat-transfer plate at the first opening.

10. The inductor according to claim 8, wherein the cover comprises: a side panel; wherein the first heat-transfer plate interconnects the heat conductor and the side panel for conducting heat from the heat conductor to the side panel.

11. The inductor according to claim 1, wherein the carrier structure is a cured epoxy resin.

12. A method for manufacturing an inductor comprising a coil and a heat conductor, the coil having an electrical conductor embedded in a carrier structure, wherein the method comprises:
positioning the heat conductor within the coil, wherein the heat conductor is spaced apart from the coil;
providing a fluid material between the heat conductor and the coil to form a precursor inner core; and
solidifying the fluid material of the precursor inner core to form a magnetic inner core of a first material,
wherein the first material has a first thermal conductivity, and the heat conductor is of a second material having a second thermal conductivity that is greater than the first thermal conductivity.

13. The method according to claim 12, wherein the fluid material is a fluid metal-powder compound.

14. The method according to claim 13, wherein the fluid material is also provided outside of the coil to form a precursor outer core connected to the precursor inner core.

15. The method according to claim 14, wherein the heat conductor and the coil are placed in a mold and the fluid material is provided between the coil and the mold to form the precursor outer core.

16. An inductor comprising:
a magnetic inner core;
a coil wound around the inner core; and
a magnetic outer core extending on the outside of the coil and connecting to the inner core, wherein the inner core has a cylindrical geometry defining a central axis, and the outer core is located at the central axis,
a heat conductor arranged within the inner core and the outer core and accessible from outside the outer core and the coil for conducting heat from the inner core to outside the inner core, wherein the inner core is of a first material having a first thermal conductivity, and the heat conductor is of a second material having a second thermal conductivity that is greater than the first thermal conductivity.

17. The inductor according to claim 16, wherein the first material is a solid metal-powder compound.

18. The inductor according to claim 16, wherein the thermal conductivity of the second material is at least three times greater than the thermal conductivity of the first material.

19. The inductor according to claim 16, wherein the heat conductor extends through the inner core and the outer core and is accessible from outside the outer core on opposite sides of the outer core.

20. The inductor according to claim 16, wherein the heat conductor is located at the central axis.

21. The inductor according to claim 16, wherein the outer core is of the same material as the inner core, and the inner core and the outer core jointly form a monolithic structure.

22. The inductor according to claim 16, wherein the inductor further comprises:
a heatsink coupled to the heat conductor and configured to receive heat from the heat conductor.

23. The inductor according to claim 22, wherein the heatsink comprises: a cover and a first heat-transfer plate coupled to the heat conductor and interconnecting the heat conductor and the cover for conducting heat from the heat conductor to the cover, and the cover comprises heat dissipating fins.

24. The inductor according to claim 23, wherein the cover comprises: a side panel; wherein the first heat-transfer plate interconnects the heat conductor and the side panel for conducting heat from the heat conductor to the side panel.
